(19) United States
(12) Patent Application Publication
(10) Pub. No.: US 2011/0255949 A1
(43) Pub. Date: Oct. 20, 2011

(54) LOADABLE CONTAINER WITH A SHELF

(75) Inventors: Jussi Lemola, Espoo (FI); Tom Mellin, Porvoo (FI)

(73) Assignee: Deutsche Post AG, Bonn (DE)

(21) Appl. No.: 13/141,419

(22) PCT Filed: Dec. 16, 2009
(86) PCT No.: PCT/EP09/09020

§ 371 Date: Jun. 22, 2011

(30) Foreign Application Priority Data
Dec. 29, 2008 (EP) 08022490.0

(51) Int. Cl. B65D 19/44; B65G 65/30; A47B 96/02

(52) U.S. Cl. 414/800; 211/86.01; 206/600

(57) ABSTRACT

There is provided a container with a pallet with a loadable upper side and a closable sidewall. The container comprises at least three sides to be placed on top of the pallet in order to define a loadable volume. The container is adapted to be collapsed in case of no loaded objects onto the upper side of the pallet. The container comprises shelves suitable to be loaded with objects and at least one side of the sidewall is suitable to be opened in order to load the pallet randomly under the shelf and on the shelf. The shelves are mounted to one of the sides of the sidewall by mounting means. The container comprises at least a first shelf mounted on a first side of the sidewall and at least a second shelf mounted on another side opposite to the first side suitable to be connected with shelf connection means.

### CROSS-REFERENCE TO RELATED APPLICATIONS

Pursuant to 35 U.S.C. §371, this application is the United States National Stage Application of International Patent Application No. PCT/EP2009/009020, filed on Dec. 16, 2009, the contents of which are incorporated by reference as if set forth in their entirety herein, which claims priority to European (EP) Patent Application No. 08 022 490.0, filed Dec. 29, 2008, the contents of which are incorporated by reference as if set forth in their entirety herein.

### BACKGROUND

Containers are used to transport loaded objects. Document DE 202005012289 discloses a stackable container with a sidewall where two side are removable mounted to four corner poles carrying permanently the other two sides of the sidewall to enable a flexible access of the loadable space and to collapse the container in case of no loaded objects around hinges at the corner poles and hinges arranged horizontally at approximately the half height of each side of the container. In case of several loaded objects with different volume and/or weight, all different objects have to be placed beside and/or on top of each other. In case of slippage and/or side impacts during transport heavy and/or large sized objects may damage the small and/or light objects inside the container. In case of a random loading process, later loaded heavy objects may have to be placed on top of earlier loaded small and/or light and/or fragile objects with a high risk of damaging these small and/or light and/or fragile objects. A loading process where heavy objects are loaded first requires higher effort to sort and classify the objects before loading. The complicated logistics for this loading process causes a slower and therefore more expensive loading process.

### SUMMARY

The subject innovation relates to a loadable container with a shelf, to a method to load this container and to a sidewall and a telescope shelf to be used in this container.

The subject innovation may provide a collapsible container for secure transport of objects with different sizes or weights enabling a random and fast loading process.

The subject innovation provides a container with a pallet with a loadable upper side and a closable sidewall comprising at least three sides to be placed on top of the pallet in order to define a loadable volume and being able to be collapsed in case of no loaded objects onto the upper side of the pallet, wherein the container comprises at least one shelf suitable to be loaded with objects and at least one side of the sidewall is suitable to be opened in order to load the upper side of the pallet and the shelf randomly. The term “closable” denotes the possibility to connect the sides of the sidewall to each other in order to form a closed sidewall. After placing the closed sidewall on top of the pallet or putting the sides on top of the pallet followed by connecting the sides of the sidewall to a closed sidewall, both sidewall and pallet define the loadable volume of the container. Optionally, the container may be covered by a cover top. Correspondingly to a closed sidewall the reverse process of detaching (opening) the sides from each other can be applied. Subsequently a container able to be collapsed is provided. In one exemplary embodiment of the sidewall, all sides are detachable from each other. In alternative exemplary embodiments, some sides are detachable from the other sides, at least one side must be detachable in order to achieve a collapsible sidewall. To collapse such a sidewall, a combination of folding sides together and detaching sides and putting these sides on top of the pallet can be applied. The advantage of an at least partly detachable sidewall is the possibility to replace sides of the sidewall in case of damage in contrast to replace the complete sidewall in case of a single damaged side saving replacement and maintenance costs. The sidewall has an open base to minimize the required parts to build a closed sidewall. A sidewall with a base is not required because the pallet form the base of the container. The required time for replacements of sides is below 1 minute. Also, damaged pallets can be replaced without replacing the whole container. The term “pallet” denotes all kind of pallets, especially pallets suitable to be moved and/or transported with forklifts. This could be standard pallets, any loadable container base plates and/or base plates/pallets with mounted wheels suitable to be transported with a forklift.

The present shelf can be loaded through the opened side enabling a fast access of the loadable volume of the pallet and the shelf simultaneously. Furthermore, small and/or light and/or fragile objects can be placed onto the shelf, while placing the large and/or heavy and/or non-fragile objects onto the loadable upper side of the pallet. Subsequently, the risk of damaging the objects on top of the shelves by slippage of the objects loaded on top of the pallet is at least reduced. Furthermore, heavy objects are loaded on top of the pallet and therefore cannot damage the objects on top of the shelves due to their weight. The simultaneous access to the loadable volume on top of the shelves as well as to the remaining volume on top of the pallet avoids any required sorting of objects before loading. Each object can be loaded independently from its weight or fragility directly to the container, either on top of the shelves or on top of the pallet. By maintaining a secure transport of objects with different properties (volume, weight, fragility), the required loading time is not extended in contrast to containers without shelves. A random and fast loading process can still be applied to a container according to the subject innovation.

In another exemplary embodiment, the container comprises further means in order to be stackable, preferably additional supporting posts are preferably located in the corners of the pallet or a cover for the sidewall to improve the stiffness of the sidewall (further strengthen the sidewall). The possibility to stack containers according to the subject innovation will lead to a further more effective use of available storage space in trucks, trailers, trains, ships, air planes etc.

In an exemplary embodiment, the sidewall and/or the shelves of the container are essentially made of at least one a material selected from the group of materials comprising cardboard, treated cardboard and plastic, preferably water resistant and/or recyclable. The use of the above listed materials provide an environmental sustainable solution and will decrease the production costs of sidewalls compared to expensive materials such as metal sidewalls or the like. Wrecked material can be recycled and turned back to functional sidewalls or part of the sidewall (first side, third side etc.). These materials still provide a secure locking structure. It is known to skilled people, that the listed materials are water resistant (plastic) or can be made water-resistant in case of cardboard or treated cardboard. Furthermore, these materials are RFID (radio frequency identification) compatible in contrast to metal containers or other containers acting as a Faraday cage, where the RFID signal of objects equipped with RFID tags inside the container cannot be detected. In alternative embodiments, at least one side, for example the side to be opened, may be a net or a frame with a net fastened to the frame, preferably only one side to keep the container to be stackable. People skilled in the art may choose alternative materials for sidewall and/or shelves within the scope of the subject innovation. In alternative embodiments, the shelf may be a net or made of cotton.

In an exemplary embodiment, the shelf is a telescope shelf suitable to be telescoped to increase its loaded size. A telescope shelf enables a fast and very flexible possibility to adapt the required loadable size of the shelves depending on the number of objects to be transported with more accuracy (if light and/or small and/or fragile). During the loading process depending on the inflow of objects, the loading operator can decide case by case, whether a larger loadable shelf is required. In a preferred embodiment, the telescope shelf is suitable to divide the loadable volume in at least two separate sub-volumes. The sub-volumes enable a better sorting of objects, e.g. objects with certain properties in a first sub-volume, objects with different properties in a second sub-volume, objects with third properties in a third sub-volume (if present) etc. The term “properties” denotes any physical or any non-physical properties, e.g. expensive/cheap or light/heavy or addressed to a first, a second or a third recipient etc. In another exemplary embodiment, the shelf is mounted to one of the sides of the sidewall by mounting means, preferably by mounting means permanently mounted to the sidewall and the shelf. The term “mounted shelf” explicitly comprises shelves formed as a part of the sidewall connected to the side of the sidewall via a material bridge, for example foldable along a line essentially at the edge between shelf and side of the sidewall. For example, the side with shelf is made of cardboard with is foldable along a line parallel to the lower edge of this side to be placed on top of the pallet. To load objects onto the shelf, the shelf is folded along this line into an upwards position suitable for loading. The mounting means to permanently mount the shelves comprise any means suitable to mount the shelves to one of the side of the sidewall. Permanently mounted mounting means cannot be lost during transport, loading and de-loading. In a more preferred embodiment, the mounting means are removably mounted to the shelf enabling the shelf to be moved in a non-loadable position in case of no required shelves. In an even more preferred embodiment, the mounting means are mounted removable to the sidewall and the shelf further enabling a separate storage of the mounting means after collapsing the container in order to achieve the very small collapsed volume. The smaller the collapsed volume of the container, the more effective is the transport of collapsed container back to the loading station, which saves transportation costs.

In another exemplary embodiment, the mounting means are suitable to rotate and/or move the shelf relative to the side of the sidewall. Here, the position of the shelf can be adapted to the loading requirements depending on the loaded objects on a case by case decision.

In a further exemplary embodiment, the mounting means are either rotatable towards the sidewall or able to be hinged into the sidewall. Here, the mounting means can be placed in a volume saving position when not needed to align the shelf in a loadable position. If rotated towards one side of the sidewall, the mounting means are in direct contact to the side. Depending on the shape of the mounting means, the container is collapsible to a smaller volume compared to mounting means not rotatable. Furthermore, in case of not required shelves, the rotated mounting means do not hamper the container to be fully loaded, because the occupied loading volume of rotated mounting means is negligible compared to the total loadable volume. A mounting means hinged into a side of the sidewall does not occupy any loading space. The previously described advantages apply even more for hinged mounting means.

In another exemplary embodiment, the mounting means comprise hinges, chains, ropes, bands, strips, ribbons, essentially L-shape mounts, buttons, posts, poles, zip fasteners, grooves to carry the shelf, frames, clips, flaps, lugs, a foldable edge between shelf and sidewall and/or combination thereof. In some embodiments, chains, ropes, bands etc may be used in combination with buttons, bolts, pins etc. to fasten said chains, ropes, bands etc. The scope of the subject innovation covers also other suitable combinations of mounting means. L-shaped mounts are only one example of suitable shaped mounts. Skilled people may choose other shapes of mounts as mounting means or not listed suitable mounting means within the scope of the subject innovation.

In a further exemplary embodiment, the container comprises at least a first shelf mounted on a first side of the sidewall and at least a second shelf mounted on another side opposite to the first side suitable to be connected with shelf connection means. Here, the advantage to provide loading volume on top of the shelves (if required) is combined with an improved stability of the complete container in case of oppositely arranged shelves mounted together. In a preferred embodiment, said shelf connection means comprise at least one frame, rail, bar, pole, post in order to support the connected first and second shelves. Such shelf connection means are able to support the shelves in order to improve their resilience against loaded weight. In a more preferred exemplary embodiment, the connected first and second shelves divide the loadable volume into at least two separate sub-volumes. The sub-volumes enable a better sorting of objects, e.g. objects with certain properties in a first sub-volume, objects with different properties in a second sub-volume, objects with third properties in a third sub-volume (if present) etc. The term “properties” denotes any physical or any non-physical properties, e.g. expensive/cheap or light/heavy or addressed to a first, a second or a third recipient etc. The mounted and connected first and second shelves provide a very stable status of a loaded container, either to protect the objects against each other or to stabilize the container against side impacts during transportation.

In another exemplary embodiment, the shelf further comprises at least one supporting means in order to increase the resilience of the shelf. As an example such supporting means may be metal bars. The supporting means may be permanently connected to the shelf or may be removable attachable to the shelf when required in case of heavy load. The supporting means may be further attached to one or more sides of the sidewall to further improve the stability of shelf and/or the container in total. People skilled in the art may choose other suitable supporting means within the scope of the subject innovation.

In another exemplary embodiment of the sidewall, the side to be opened is an element of the list of elements comprising a side detachable from the other sides of the sidewall via connection means to close and open the sidewall, a door, a double wing door, a net or a frame holding a net. Suitable connection means comprise clips, flaps, pins, bolts anchors, clamps, clips, mounting links and hooks to provide a closed sidewall. In case of the side to be opened as a door, but as a replaceable element to open the container, this side is detached front the remaining sides of the sidewall to load the container. After loading, the side is connected again to the other sides in order to provide a closed sidewall for the following transportation. In another exemplary embodiment, the side to be opened is provided as a door, preferably a double wing door, connected to the vertical edge of the one side and/or another side facing towards the side to be opened via at least one opening means. When the container should be loaded the door will be opened along the vertical edge of one side, in case of a single wing door. In case of a double wing door, both wings will be opened along the vertical edges of the neighboring side to provide easy access to the whole loadable volume of the container. The opening angle provided by the opening means of the door (e.g hinges) allows different handling procedures. In another exemplary embodiment, the opening means are suitable to provide an opening angle of the door (or double wing door) of 90°, preferably 180°, more preferred 270°.

In another exemplary embodiment, all sides of the sidewall are connected with connection means in order to be detached to collapsed the container in case of no load. In this case, all sides can be replaced by other sides in case of damaged sides. There is no unnecessary waste of non-damaged sidewall material.

The subject innovation further relates to a method to load a container, comprising:
opening at least one side of the sidewall,
preparing the at least one shelf to be loaded with objects, and
loading the objects randomly onto the at least one shelf or onto the loadable upper side of the pallet through the open side of the sidewall

Loading the container through an open side enables simultaneous loading of shelves and pallet. In contrast to that, a loading only through an open top would require additional logistics effort, because the volume below the shelves has to be loaded first. After loading the upper side of the pallet, the volume below the shelves is not accessible anymore in case of no open side of the sidewall. Preparing of the shelves to be loaded is required, because the shelves might by rotated towards the sides of the sidewall, or the shelves to be mounted are placed on top of the upper side of the pallet and has to be mounted to the sides of the sidewall, or has to be placed on top of the upper side of the pallet both in case of space saving storage of the non-loaded shelves within the container in a collapsed manner.

In an exemplary embodiment of the method, the step of preparing the at least one shelf to be loaded further comprises arranging the shelf at least one side of the sidewall in case of a non-mounted shelf, preferably if the shelf is a telescope shelf followed by telescoping the telescope shelf to increase its loadable size. The shelf is placed at a side of the sidewall in order to have a stable position within the container and enabling the full access to the remaining loadable volume.

In an alternative exemplary embodiment of the method, the step of preparing the at least one shelf to be loaded further comprises aligning the shelf in an loadable position, preferably an essentially horizontal position, and fastening the loadable position with mounting means, preferably if the shelf is a telescope shelf followed by telescoping the telescope shelf to increase its loadable size. The term “aligning” denotes the process of mounting and/or moving and/or rotating the shelf to a usable position at least one of the sides of the sidewall. A usable position is commonly a horizontal position of the loadable surface of the shelf. In case of very small object, e.g bulk cargo, the shelf may be formed as a bag, pocket, bin or cavity. Here a usable position may deviate from an essentially horizontal position. The term “essentially horizontal” denotes shelves, where the upper side has a position sufficient to hold the objects onto the shelf, for example with a slope small enough to prevent slippage of the objects placed onto the shelf.

The subject innovation further relates to a closable sidewall suitable to be used in a container comprising at least three sides being able to be collapsed, with at least one side of the sidewall suitable to be opened and at least one shelf suitable to be loaded with objects mounted to one of the sides of the sidewall by mounting means, preferably permanently mounted to the sidewall and the shelf, more preferably removable mounted to the shelf, most preferably mounted removable to the sidewall and the shelf, because the sidewall can be commercialized independently from the container.

The innovation further relates to a telescope shelf to be used in a closable container or to be used in a closable sidewall because the telescope shelf can be commercialized independently from the container.

The previously described embodiments may be combined by skilled people within the scope of the subject innovation. A container according to the subject innovation may comprise several shelves, one or more of the shelves may be placed inside the container without mounting said shelves to the sidewall, one or more shelves may be mounted to one or more sides of the sidewall, one or more shelves may be telescope shelves, one or more telescope shelves may be suitable to divide the loadable volume of the container in two or more sub-volumes, one or more shelves may comprise different mounting means, where some mounting means may be rotatable and other mounting means may be movable relative to one or more sides of the sidewall.

Additional details, characteristics and advantages of the subject innovation are disclosed in the following description of the respective figures—which are in exemplary fashion only—showing the plurality of preferred embodiments of a loadable container according to the subject innovation.

### BRIEF DESCRIPTION OF THE DRAWINGS

FIG. 1 is a diagram of a container according to the subject innovation in a perspective view;

FIG. 2 is a series of side views of second side (a), first side (b) and third side (c) with a double wing door as the fourth side, and a top view of the pallet (d) of the container according to the subject innovation;

FIG. 3 is a diagram of an opened container according to the subject innovation with two shelves mounted at two sides of the sidewall;

FIG. 4 is a diagram of the container as shown in FIG. 3 with shelves dividing the loadable volume in two sub-volumes;

FIG. 5 is a perspective view showing a sidewall with mounted telescope shelf;

FIG. 6 is a perspective view showing part of the sidewall with mounted rotatable shelf;

FIG. 7 is a diagram showing a forklift stacking two container according to the subject innovation; and

FIG. 8 is a diagram showing a partly collapsed container and stacked fully collapsed containers.

### DETAILED DESCRIPTION OF SPECIFIC EMBODIMENTS

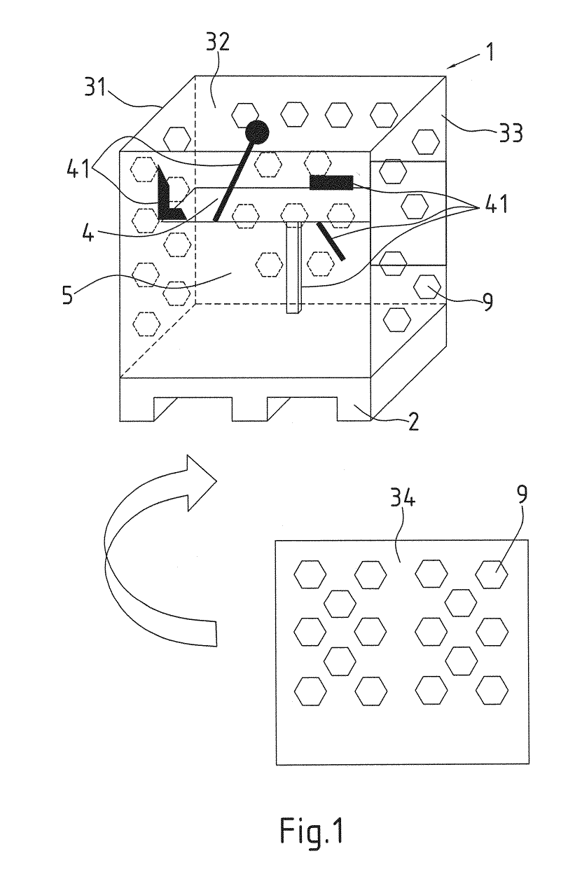

FIG. 1 shows a container 1 according to the subject innovation in a perspective view. The pallet 2 is shown as a black bottom. The sidewall 31, 32, 33, 34 is placed onto the pallet 2 in order to define a loadable volume 5. The sidewall in FIG. 1 has four sides, a first side 31, a second side 32, a third side 33 and a fourth 34. In alternative exemplary embodiments the sidewall may have only three sides or more than 4 sides to build of closable sidewall to be placed on top of the pallet 2. In the following, the subject innovation is explained for a container comprising a sidewall with four sides. For a better view, the details of the fourth side 34 are shown separately below the container. The arrow indicates, that the fourth side 34 is located on the pallet between first side 31 and third side 33 as part of the sidewall.

The container comprises at least one shelf 4 arranged or mounted at least at one side of the sidewall, in this example mounted with mounting means 41 at the sidewall. FIG. 1 shows several different mounting means as an example of the variety of possible mounting means. The shelf 4 may be mounted only with one of the shown mounting means 41. In other exemplary embodiments, two or more mounting means 41 may be used to mount the shelf 4 to the sidewall. There may be a combination of different mounting means to mount the shelf. The mounting means could be mounted at the side 32 of the sidewall, where the shelf 4 is attached to or may be mounted to the neighbored side 31, 33 of the sidewall to fasten the shelf 4 in a loadable position. Alternatively there may be mounting means 41 placed on top of the upper side of the pallet 2 in order to fasten the shelf 4 in a loadable position as shown in FIG. 1 with a post below the shelf 4. The mounting means 41 can be arranged above or below the shelf. There may be also mounting means 41 formed as a carrier rail mounted to two neighbored sides 31, 33 of the sidewall, where the shelf 4 extending over the whole width of the container is inserted to. Skilled people may consider alternative mounting means 41 within the scope of the subject innovation.

The sidewall 31, 32, 33, 34 of FIG. 1 comprises openings 9 to lower the weight of the sidewall. The hexagonal shape of the openings 9 is only one possible example and the openings may have any other shape in other embodiments. In alternative exemplary embodiments, the sidewall may have no openings in order to improve the stiffness (strength) of the container in order to be stackable. However, also containers with openings 9 can be stacked, if the stiffness of the sidewall is sufficient, for example depending on the thickness of the sidewall, its material and the size and weight of the container to be stacked. To further support a stacking of the containers, additional poles may be placed on top of the pallet, e.g. one post in each corner with a flat top to stack the next container on top of the poles. Eventually present first and second fastening means to fasten the sidewall on top of the pallet and the closing means of the sidewall are not shown is this figure.

The fourth side 34 in FIG. 1 can be attached and detached from the first side 31 and second side 33 in order to open the container 1 to load the container with objects. If detached, the fourth side 34 may be taken away from the pallet 2 using suitable holders. People skilled in the art may choose suitable means, arrangements and shapes to remove the fourth side 34 from the remaining sidewall 31, 32, 33 and pallet 2.

The size of pallet 2 and sidewall 31, 32, 33, 34 can be customized and may have any desired length, depth and height. However, containers (pallet+sidewall) adapted to available storage spaces in trucks, trailers, trains, ships and air planes are advantageous, because the effective use of the available space to transport objects decreases the transportation costs and time.

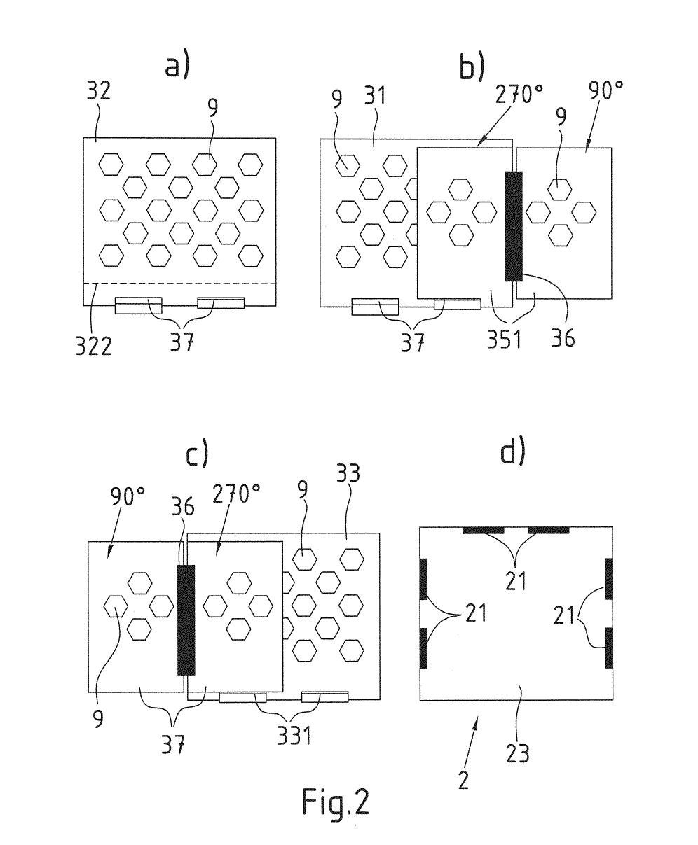

The container 1 comprises a pallet 2, a sidewall with a first side 31, a second side 32, a third side 33 and a fourth side 34, which can be a door or a double wing door 351, 352 as shown in FIG. 2. FIG. 2 shows the parts of the container 1 as side views for (a) the second side 32, (b) the first side 31, (c) the third side 33 and (d) a top view of the pallet 2. Here, the fourth side 34 is a double wing door, where a first wing of the door 351 is attached to the first side 31 via opening means 36 to hold and open the first wing 351. Correspondingly, a second wing 352 of the double wing door is attached to the third side 33 via opening means 36 to hold and open the door. The opening means 36 can be identical for both first and second wings 351 and 352 or may be different depending on the desired opening characteristics. People skilled in the art will select the appropriate opening means 36 for the desired opening characteristics. As an example, the wings 351 and 352 are shown in FIG. 2 in two different positions, with an opening angle of 90° and another opening angle of 270°. The minimum opening angle required to be able to load the complete loadable volume directly is 90°. The maximum opening angle is 270°, when the door wing(s) contact the outside surface of the first and/or the third side. The opening means may provide any maximum opening angle between 90° and 270°. In an alternative embodiment with a single wing door as the fourth side 34, the previously discussed features and limitations are valid also. The opening means 36 may enable the door wings turned to the inside surface of the first and/or third side. The opening angle of 90° to the inside of the container should not be used for loading the container, because the door wings cannot be closed after loading, but this opening angle might be important to collapsed the sidewall of the container, where the door wings are still fixed to the first and/or third side via the opening means 36. The first and second wings 351 and 352 of the double wing door as the fourth side 34 may comprise closing means. The closing means will further secure the loaded objects within the container from getting lost during transport, because a locked door cannot be opened accidentally. People skilled in the art will chose appropriate closing means in order to lock the door safety. In alternative exemplary embodiments, there are 2, 3 4 or more closing means on each door or door wing.

The connection means to connect the parts of the sidewall, the first side 31, the second side 32, the third side 33, the fourth side 34 or the door 351 and 352, together in order to build a closed sidewall enclosing the loaded objects of the container are not shown in details in FIG. 2. People skilled in the art will chose any appropriate connection means to connect said parts. Examples of appropriate connection means are clips, flaps, pins, bolts anchors, clamps, clips, mounting links and hooks. The number and position of the connecting means on the parts of the sidewall may be chosen by skilled people depending on size, maximum load, material etc. of sidewalls and pallets.

The square shape of the pallet 2 in FIG. 2 is only one example of any possible shapes. However, a square shape with adapted sizes may be advantageous for certain available storage spaces in transporting vehicles such as trucks, trailers, trains, ships, air planes etc. The pallet 2 comprises first fastening means 21 arranged at three sides of the pallet in order to fit into the corresponding second fastening means 37 of the sidewall in order to fasten the sidewall 31, 32, 33, 351 and 352 (=34) on the pallet 2. The pallet shown in FIG. 2 has no first fastening means at the fourth side, because the fourth side is arranged as a double wing door in this example. Fastening means at the fourth side would hamper opening of the door. Additional, fastening means at the fourth side in case of the fourth side as a door are not required, because the door 351 and 352 is fastened to the pallet 2 via the opening means 36 fastening the door 351,352 to the first and third side 31, 33 and via the fastening means 37 of left and right side 31 and 33 to the pallet 2. In this example, the first fastening means 21 are rectangular protrusions such as ledges, edges, lugs etc. The sidewall has corresponding recesses or notches as second fastening means 37 fitting onto the first fastening means. During collapsing the container, the first side 31 and the third side 33 can be turned towards the upper side 23 of the pallet 2 by turning these sides around the first fastening means 21 onto the pallet 2. After collapsing the first and third sides 31 and 33, the fastening means 21, 37 are still in fitting contact, if protrusion and recess are of appropriate height. The collapsing procedure may be further supported by additional bolts, pins etc. improving the fastening of first and second fastening means while simultaneously maintain the rotatability of the first and third side along the first fastening means. Examples of appropriate first and second fastening means are hinges, clips, flaps, pins, bolts, clamps, clips, mounting links, angle, hooks, local ledges, local edges or combinations thereof. People skilled in the art might chose alternative fastening means within the scope of the subject innovation. During the collapsing process the shelves should to be collapsed first. The shelves may be rotated towards the sides of the sidewall or may be detached from the sidewall and collapsed and/or stored separately. The same applies to shelves not mounted to the sidewall.

The openings 9 shown in FIG. 2 are only one possible example to design the sidewall. Sidewalls according to the subject innovation may have different numbers of openings, openings with different shape or no openings.

The second side 32 further comprises a foldable line 322 in order to move the second side 32 towards the upper side of the pallet 23 as the last step of the collapsing procedure for the container. A second side with such foldable line 322 can be kept fastened to the pallet also in the collapsed status of the container. Therefore second sides 32 with foldable lines 322 may have different second fastening means to fit into the first fastening means of the pallet at the side corresponding to the second site of the sidewall. In alternative exemplary embodiments, the first fastening means 21 of the pallet at this side could be different to the first fastening means at the sides of the pallet corresponding to the first and third sides of the sidewall.

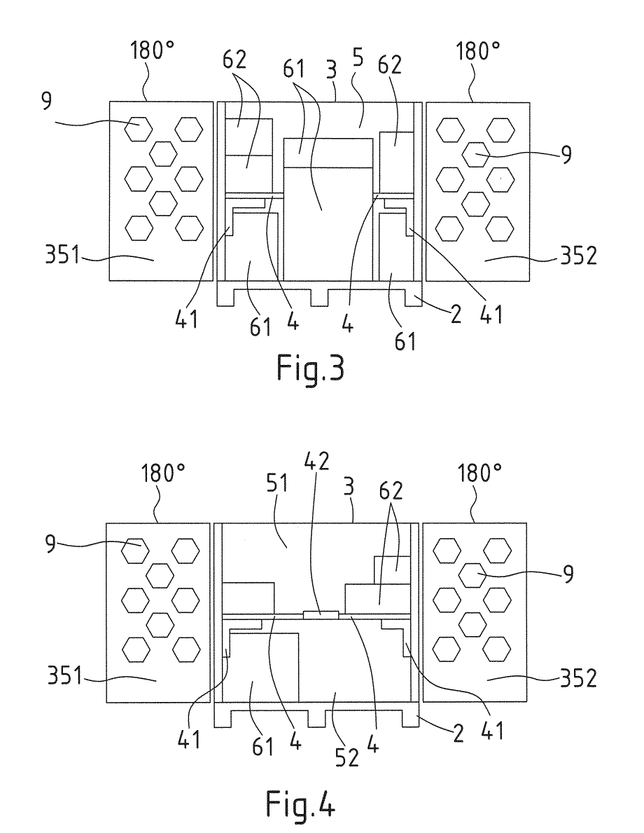

FIG. 3 shows a container 1 loaded with objects 61, 62 from a front view with opened fourth side 34 as an opened double wing door 351, 352, where the opening angle of the door wings is 180°. An opening angle larger than 90° improves the possibility to load the container from larger angles. The sidewall secures the loaded objects against slipping during transport and provides protection against side impacts. The closed sidewall will prevent the loss of objects in comparison to lose load pallets. Two shelves 4 are mounted on opposite sides of the sidewall (here in a side view) with L-shaped mounts as the mounting means 41. Small and/or light and/or fragile objects 62 are placed on top of the shelf aligned to an essentially horizontal position relative to the upper side of the pallet. Heavy and/or large sized objects 62 are loaded on top of the upper side of the pallet either below the shelves or in the loadable volume 5 between the shelves. The shelves 4 and the remaining loadable volume can be randomly loaded without any previous logistics to sort the objects according to their properties or to apply a certain flow of objects in a sequence according to their properties.

FIG. 4 shows an alternative embodiment of the container according to the subject innovation in comparison to FIG. 3. Here, the opposite shelves 4 are connected by shelf connecting means 42 to divide the loadable volume 5 (as shown in FIG. 3) into two separate sub-volumes 51 (above the shelves) and 52 (below the shelves). The objects 61 and 62 can be transported separately, e.g. sorted by recipient etc with a first recipient for the objects of sub-volume 51 and a second recipient for the objects of second sub-volume 52.

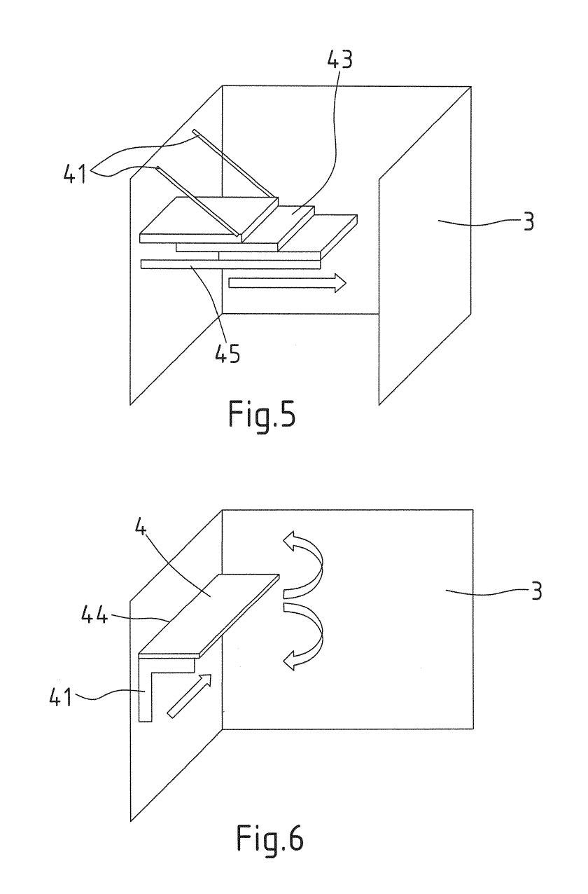

FIG. 5 shows a sidewall 3 with a mounted telescope shelf 43, which loadable size can be increased if needed (see arrow). As an example the telescope shelf is mounted via ropes at one side of the sidewall. A support means 45, for example a metal bar mounted below the telescope shelf 45 may support the resilience of the telescope shelf. The support 45 may also be present below other shelves 4 in other embodiments. The shown position below the telescope shelf is only an example. People skilled in the art may choose other positions of supporting means within the scope of the subject innovation.

FIG. 6 shows a shelf 4 attached at one side of the sidewall 3 aligned to a horizontal position by L-shaped mounting means 41. The shelf in FIG. 6 is part of the sidewall 3 (permanently attached) rotatable towards the sidewall (see gray arrow) and upwards (inverted arrow) to a loadable position via a foldable line 44. Alternatively the foldable line may be replaced by permanently mounted hinges etc. To be able to rotate the shelf 4 itself, the mounting means 41 (L-shaped mount) is rotatable mounted at the sidewall 3. The L-shaped mount 41 can be rotated towards the side of the sidewall 3 in order to subsequently rotate the shelf 4 towards the sidewall 3 along the foldable line 44. Alternatively, during the collapse process of the container, the shelf may be rotated upwards towards the side of the sidewall 3 along the foldable line 44. People skilled in the art may choose other alternatives to rotate/move the shelves towards the sidewall within the scope of the subject innovation

FIG. 7 shows two stacked containers 1, where the second container is stacked on top of the first container with a forklift 7. The pallet 2 as part of the container 1 enables handling of the containers by forklifts 7, which saves time and therefore costs in case of large and/or heavy weight containers. The stiffness of the sidewall has to be sufficient to stack at least another container on top of the first container. Pallet and loadable volume define a maximum load weight. The stiffness of the sidewall has to be adapted to this maximum load weight in order to be stackable, e.g. by adding support posts. Thickness of the sidewall and material of the sidewall are two other possible parameters determining the stiffness of the sidewall within the scope of the subject innovation, if necessary.

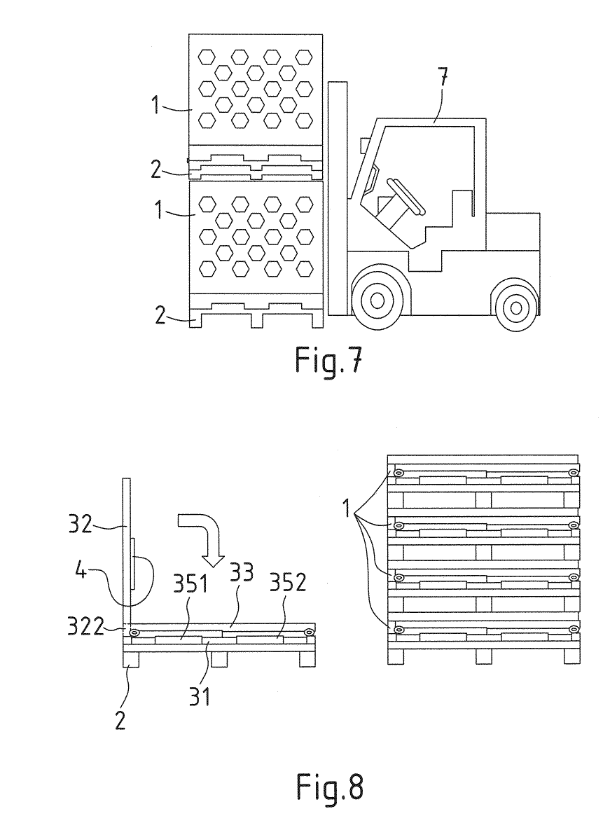

To collapse the container, the connection means of the sidewall have to be opened. In one exemplary embodiment, all connection means are opened first before starting to collapse the container. In an alternative exemplary embodiment, only the connection means of the part of the sidewall to be collapsed are opened. Then the part of the sidewall will be collapsed and the next connection means of the next part of the sidewall are opened in order to be able to collapse the next part of the sidewall and so on. The FIG. 8 shows a partly collapsed container 1 (left side) with a shelf 4 mounted to the second side 32 of the sidewall already rotated towards the second side 32 (the corresponding mounting means are not shown here) and a stack of 4 fully collapsed containers 1 (right side). As one possible example of collapsing procedures, the first side 31 connected to the first wing 351 of the double wing door is placed on top of the upper side of the pallet 2 with the first wing 351 turned to 270° to the outer side of the first side 31 (first side and door are into contact). To fit to the first side with door, the third side 33 and the second wing 352 of the double wing door are detached from the pallet and are turned around and the second wing is turned to 90° to the inner side of the third side 31 (third side and door are into contact). Here the term “inner side” denotes the surface of the sidewall, which is the inner side of the container. Correspondingly, the term “outer side” denotes the surface of the sidewall, which is the outer side of the container. The sequence may be altered and the above described procedure can to be executed in an inverted manner resulting in an equivalent status of the partly collapsed container. As the last step of collapsing the container, the second side may be folded along the foldable line 322 towards the previously collapsed first and third sides 31, 33 with attached door 351, 352. In this embodiment, the second fastening means 321 of the second side 32 are kept fastened to the first fastening means 21 of the pallet 2 of its side corresponding to the second side of the sidewall. Alternatively, a second side 32 without a foldable line 322 might be detached from the pallet 2 and placed on top of the previously collapsed first and second sides with attached door. In case of a fourth side 34 not arranged as a door 351, 352, the fourth side 34 may replace the layer of first and second door wings 351 and 352 as shown in FIG. 8. Alternatively, the fourth side 34 may be placed on top of the collapsed first and third sides. However, all previously disclosed collapsing methods lead to a dense package of the collapsed sidewall. This is advantageous in case of stacked transport of collapsed containers, because the weight of collapsed containers will not damage the collapsed containers below, if the collapsed sidewalls are in a dense package at least similar to the package shown in FIG. 8.

The shown embodiments must not be considered as limitation of the subject innovation. The discussed embodiments are only examples of the subject innovation. People skilled in the art may consider alternative embodiments to those disclosed herein still falling into the scope of the subject innovation.

### LIST OF REFERENCE SIGNS

1 container according to the subject innovation
2 pallet
21 first fastening means
23 upper side of the pallet
3 closable sidewall
31 side of the sidewall
32 side of the sidewall
33 side of the sidewall
34 side of the sidewall to be opened
36 opening means
37 second fastening means
322 foldable line of a side of the sidewall
351 first wing of double wing door
352 second wing of double wing door
4 shelf
41 mounting means
42 shelf connection means
43 telescope shelf
44 foldable line
45 supporting means
5 loadable volume
51 first loadable sub-volume
52 second loadable sub-volume
61 objects loaded on top of the pallet
62 objects loaded on top of the shelf
7 forklift
9 openings

1-15. (canceled)

16. A container with a pallet with a loadable upper side and a closable sidewall comprising at least three sides to be placed on top of the pallet in order to define a loadable volume and being able to be collapsed in case of no loaded objects onto the upper side of the pallet, wherein the container comprises shelves suitable to be loaded with objects and at least one side of the sidewall is suitable to be opened in order to load the pallet randomly under the shelf and on the shelf, wherein the shelves are mounted to one of the sides of the sidewall by mounting means and wherein the container comprises at least a first shelf mounted on a first side of the sidewall and at least a second shelf mounted on another side opposite to the first side suitable to be connected with shelf connection means.

17. The container recited in claim 16, wherein the shelf is a telescope shelf suitable to be telescoped to increase its loaded size, thereby to divide the loadable volume in at least two separate sub-volumes.

18. The container recited in claim 16, wherein the shelf is permanently mounted to the sidewall and the shelf, is removably mounted to the shelf, or to the sidewall and the shelf.

19. The container recited in claim 16, wherein the mounting means rotate and/or move the shelf relative to the side of the sidewall.

20. The container recited in claim 19, wherein the mounting means are rotatable towards the sidewall or able to be hinged into the sidewall.

21. The container recited in claim 20, wherein the mounting means comprise hinges, chains, ropes, bands, strips, ribbons, essentially L-shape mounts, posts, poles, buttons, zip fasteners, grooves to carry the shelf, frames, clips, flaps, lugs, a foldable edge between shelf and sidewall and/or combinations thereof.

22. The container recited in claim 16, wherein the shelf connection means comprise at least one frame, rail, bar, pole, post in order to support the connected first and second shelves, the connected first and second shelves dividing the loadable volume into at least two separate sub-volumes.

23. The container recited in claim 16, wherein the shelf further comprises at least one supporting means that acts to increase the resilience of the shelf.

24. The container recited in claim 16, wherein the side of the sidewall to be opened is an element of the list of elements comprising a side detachable from the other sides of the sidewall via connection means to close the sidewall, a door, a double wing door, a net and a frame holding a net.

25. The container recited in claim 16, wherein the sides of the sidewall are connected with connection means in order to be detached to collapsed the container in case of no load.

26. A method of loading a container with a pallet with a loadable upper side and a closable sidewall comprising at least three sides to be placed on top of the pallet in order to define a loadable volume and being able to be collapsed in case of no loaded objects onto the upper side of the pallet, wherein the container comprises shelves suitable to be loaded with objects and at least one side of the sidewall is suitable to be opened in order to load the pallet randomly under the shelf and on the shelf, wherein the shelves are mounted to one of the sides of the sidewall by mounting means and wherein the container comprises at least a first shelf mounted on a first side of the sidewall and at least a second shelf mounted on another side opposite to the first side suitable to be connected with shelf connection means, the method comprising:
opening at least one side of the sidewall;
preparing the at least one shelf to be loaded with objects; and
loading the objects randomly onto the at least one shelf or onto the loadable upper side of the pallet through the open side of the sidewall.

27. The method recited in claim 26, wherein preparing the at least one shelf to be loaded with objects comprises:
arranging the shelf at least one side of the sidewall in case of a non-mounted shelf, the shelf being a telescope shelf; and
telescoping the telescope shelf to increase its loadable size.

28. The method recited in claim 26, wherein preparing the at least one shelf to be loaded with objects comprises:
aligning the shelf in an loadable position, preferably a horizontal position;
fastening the loadable position with mounting means, the shelf being a telescope shelf; and
telescoping the telescope shelf to increase its loadable size.

29. A closable sidewall configured to be used in a container with a pallet with a loadable upper side and a closable sidewall comprising at least three sides to be placed on top of the pallet in order to define a loadable volume and being able to be collapsed in case of no loaded objects onto the upper side of the pallet, wherein the container comprises shelves suitable to be loaded with objects and at least one side of the sidewall is suitable to be opened in order to load the pallet randomly under the shelf and on the shelf, wherein the shelves are mounted to one of the sides of the sidewall by mounting means and wherein the container comprises at least a first shelf mounted on a first side of the sidewall and at least a second shelf mounted on another side opposite to the first side suitable to be connected with shelf connection means, the closable sidewall comprising:
at least three sides being able to be collapsed, with at least one side of the sidewall suitable to be opened and at least one shelf suitable to be loaded with objects mounted to one of the sides of the sidewall by mounting means, the shelf being removably mounted to the sidewall and shelf.

30. A telescope shelf to be used in a container with a pallet with a loadable upper side and a closable sidewall comprising at least three sides to be placed on top of the pallet in order to define a loadable volume and being able to be collapsed in case of no loaded objects onto the upper side of the pallet, wherein the container comprises shelves suitable to be loaded with objects and at least one side of the sidewall is suitable to be opened in order to load the pallet randomly under the shelf and on the shelf, wherein the shelves are mounted to one of the sides of the sidewall by mounting means and wherein the container comprises at least a first shelf mounted on a first side of the sidewall and at least a second shelf mounted on another side opposite to the first side suitable to be connected with shelf connection means.

31. A telescope shelf to be used in conjunction with a closable sidewall, the closable sidewall being configured to be used in a container with a pallet with a loadable upper side and a closable sidewall comprising at least three sides to be placed on top of the pallet in order to define a loadable volume and being able to be collapsed in case of no loaded objects onto the upper side of the pallet, wherein the container comprises shelves suitable to be loaded with objects and at least one side of the sidewall is suitable to be opened in order to load the pallet randomly under the shelf and on the shelf, wherein the shelves are mounted to one of the sides of the sidewall by mounting means and wherein the container comprises at least a first shelf mounted on a first side of the sidewall and at least a second shelf mounted on another side opposite to the first side suitable to be connected with shelf connection means, the closable sidewall comprising at least three sides being able to be collapsed, with at least one side of the sidewall suitable to be opened and at least one shelf suitable to be loaded with objects mounted to one of the sides of the sidewall by mounting means, the shelf being removably mounted to the sidewall and shelf.
